(19) United States
(12) Patent Application Publication
(10) Pub. No.: US 2025/0008535 A1
(43) Pub. Date: Jan. 2, 2025

(54) COMMUNICATION APPARATUS AND COMMUNICATION METHOD FOR ALLOCATING ONE OR MORE ADDITIONAL OPERATING WINDOWS FOR A SIDELINK SIGNAL

(71) Applicant: Panasonic Intellectual Property Corporation of America, Torrance, CA (US)

(72) Inventors: Yang KANG, Singapore (SG); Hidetoshi SUZUKI, Kanagawa (JP); Hong Cheng Michael SIM, Singapore (SG); Xuan Tuong TRAN, Singapore (SG); Yoshihiko OGAWA, Kanagawa (JP)

(21) Appl. No.: 18/294,936

(22) PCT Filed: Jul. 18, 2022
(86) PCT No.: PCT/SG2022/050505

§ 371 Date: Feb. 2, 2024

(30) Foreign Application Priority Data
Aug. 6, 2021 (SG) 10202108650V

(51) Int. Cl. H04W 72/40; H04W 52/02; H04W 72/0446; H04W 72/23

(52) U.S. Cl. CPC H04W 72/40; H04W 52/0216; H04W 72/0446; H04W 72/23

(57) ABSTRACT

The present disclosure provides a communication apparatus and a communication method for allocating one or more additional operating windows for a reception or a transmission of a sidelink signal. The communication apparatus comprises circuitry which, in operation, is configured to allocate one or more additional operating windows between a first operating window and a second operating window for a reception or a transmission of a sidelink signal, and a transceiver which, in operation, transmit or receive a sidelink signal within the one or more additional operating window.

### TECHNICAL FIELD

The following disclosure relates to a communication apparatus and a communication method for transmitting or receiving a sidelink (SL) signal, and more particularly for allocating one or more additional operating windows between two SL discontinuous reception (SL DRX) cycles for a SL signal.

### BACKGROUND

SL DRX was one of the working items handled by RAN2 in release 17. In RAN1 #104-e meeting a liaison was received from RAN2 to check if any concerns on taking physical sidelink control channel (PSCCH) monitoring also for sensing into account, in addition to a data reception, if a SL DRX is used.

In the third generation (3G) of mobile telecommunication technology of Universal Mobile Telecommunications System (UMTS), its Radio Access Network (RAN) is named as UMTS Terrestrial Radio Access Network (UTRAN). The air interface between UTRAN and User Equipment (UE) is also referred to as Uu interface. The same name of Uu interface is also used for the interface between UE and RAN for Long Term Evolution (LTE), LTE Advanced (LTE-A, also referred as the fourth generation (4G) of mobile telecommunication technology), LTE Advanced Pro (LTE-A Pro) and the fifth generation (5G) of mobile telecommunication technology. For UEs with Uu interface to RAN and configured with DRX features, their DRX cycles (with its on- and off-durations) are semi-statically configured, and they could remain active by extending their on-durations with drx-inactivity or drx-Retransmission timers, which is triggered by physical downlink control channel (PDCCH).

In SL communication, a SL DRX cycle would also be semi-statistically configured by upper layers for both active and inactive durations similar to Uu DRX. However, for SL, especially for mode 2 UEs, as there is no controlling gNB (base station), and majority transmission are sensing-based, SL DRX configurations might have low correlation (i.e. small fraction of On-Duration overlaps) between different UEs. This causes a major problem on how sensing is performed when a sensing window is allocated in the semi-static inactive duration.

There is thus a need for a communication apparatus and a communication method for allocating one or more additional operating windows between a first and a second operating windows (e.g., SL DRX cycles) to solve the above-mentioned issues for a reception or a transmission of a sidelink signal. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for multi-link traffic indication map.

In a first aspect, the present disclosure provides a communication apparatus comprising: circuitry which, in operation, is configured to allocate one or more additional operating windows between a first operating window and a second operating window for a reception or a transmission of a sidelink signal; and a transceiver which, in operation, transmit or receive a sidelink signal within the one or more additional operating window.

In a second aspect, the present disclosure provides a communication method comprising: allocating one or more additional operating windows between a first and a second operating windows for a reception or a transmission of a sidelink signal; and transmitting or receiving a sidelink signal within the one or more additional operating window.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 shows an exemplary 3GPP NG-RAN architecture.

FIG. 2 depicts a schematic drawing which shows functional split between NG-RAN and 5GC.

FIG. 3 depicts a sequence diagram for radio resource control (RRC) connection setup/reconfiguration procedures.

FIG. 4 depicts a schematic drawing showing usage scenarios of Enhanced mobile broadband (eMBB), Massive Machine Type Communications (mMTC) and Ultra Reliable and Low Latency Communications (URLLC).

FIG. 5 shows a block diagram showing an exemplary 5G system architecture for Vehicle-to-everything (V2X) communication in a non-roaming scenario.

FIG. 6 shows a block diagram illustrating a first operating window and a second operating window.

FIG. 7 shows a schematic example of communication apparatus in accordance with various embodiments. The communication apparatus may be implemented as a UE and configured for allocating one or more additional operating window for a sidelink signal in accordance with various embodiments of the present disclosure.

FIG. 8 shows a flow diagram illustrating a communication method for allocating one or more additional operating window for a sidelink signal in accordance with various embodiments of the present disclosure.

FIG. 9 shows a block diagram illustrating a contiguous operating window allocated between a first operating window and a second operating window of a UE and extended from the second operating window according to an embodiment of the present disclosure.

FIG. 10 shows a block diagram illustrating a contiguous operating window allocated between a first operating window and a second operating window of a UE and extended from the second operating window according to another embodiment of the present disclosure.

FIG. 11 shows a block diagram illustrating a contiguous operating window allocated between a first operating window and a second operating window of a UE and extended from the first operating window according to an embodiment of the present disclosure.

FIG. 12 shows a block diagram illustrating a contiguous operating window allocated between a first operating window and a second operating window of a UE and extended from the first operating window according to another embodiment of the present disclosure.

FIG. 13 shows a block diagram illustrating an additional operating window allocated between a first operating window and a second operating window of a UE configured with a sensing window according to an embodiment of the present disclosure.

FIG. 14 shows a block diagram illustrating an additional operating window allocated between a first operating window and a second operating window of a UE and configured with a sensing window according to another embodiment of the present disclosure.

FIG. 15 shows a block diagram illustrating five discrete operating windows allocated between a first operating window and a second operating window of a UE and separated from the first and the second operating windows according to an embodiment of the present disclosure.

FIG. 16 shows a flow chart illustrating a process of allocating one or more additional operating windows between a first operating window and a second operating window carried out by a communication apparatus according to various embodiments of the present disclosure.

FIG. 17 shows a flow chart illustrating a process of allocating one or more additional operating windows between a first operating window and a second operating window carried out by a transmitter (Tx) communication apparatus according to various embodiments of the present disclosure.

FIG. 18 shows a flow chart illustrating a process of allocating one or more additional operating windows between a first operating window and a second operating window carried out by a receiver (Rx) communication apparatus according to various embodiments of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

3GPP has been working at the next release for the 5th generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

The second version of the 5G standard was completed in June 2020, which further expand the reach of 5G to new services, spectrum and deployment such as unlicensed spectrum (NR-U), non-public network (NPN), time sensitive networking (TSN) and cellular-V2X.

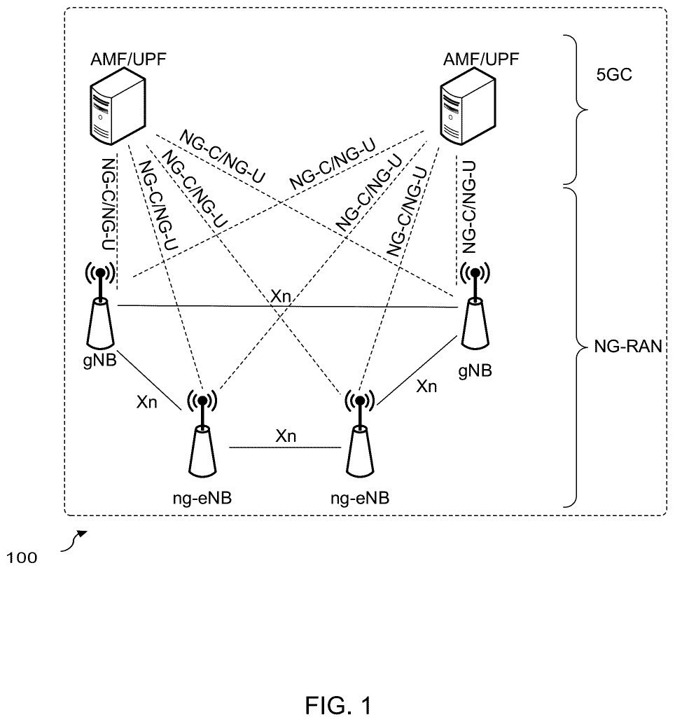

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v16.3.0).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY hybrid automatic repeat request (HARQ) processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink, PDSCH (Physical Downlink Shared Channel), PDCCH (Physical Downlink Control Channel) and PBCH (Physical Broadcast Channel) for downlink, and PSSCH (Physical Sidelink Shared Channel), PSCCH (Physical Sidelink Control Channel) and Physical Sidelink Feedback Channel (PSFCH) for sidelink (SL).

SL supports UE-to-UE direct communication using the SL resource allocation modes, physical layer signals/channels, and physical layer procedures. Two SL resource allocation mode are supported: (a) mode 1, where the SL resource allocation is provided by the network; and (b) mode 2, where UE decides SL transmission resource in the resource pool(s). PSCCH indicates resource and other transmission parameters used by a UE for PSSCH. PSCCH transmission is associated with a demodulation reference signal (DM-RS). PSSCH transmits the transport blocks (TBs) of data themselves, and control information for HARQ procedure and channel state information (CSI) feedback triggers, etc. At least 6 Orthogonal Frequency Division Multiplex (OFDM) symbols within a slot are used for PSSCH transmission. PSSCH transmission is associated with a DM-RS and may be associated with a phase-tracking reference signal (PT-RS).

PSFCH carries HARQ feedback over the SL from a UE which is an intended recipient of a PSSCH transmission to the UE which performed the transmission. PSFCH sequence is transmitted in one PRB repeated over two OFDM symbols near the end of the SL resource in a slot.

The SL synchronization signal consists of SL primary and SL secondary synchronization signals (S-PSS, S-SSS), each occupying 2 symbols and 127 subcarriers. Physical Sidelink Broadcast Channel (PSBCH) occupies 9 and 5 symbols for normal and extended cyclic prefix cases respectively, including the associated demodulation reference signal (DM-RS).

Regarding physical layer procedure for HARQ feedback for sidelink, SL HARQ feedback uses PSFCH and can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

In SL resource allocation mode 1, a UE which received PSFCH can report SL HARQ feedback to gNB via PUCCH or PUSCH.

Regarding physical layer procedure for power control for sidelink, for in-coverage operation, the power spectral density of the SL transmissions can be adjusted based on the pathloss from the gNB; whereas for unicast, the power spectral density of some SL transmissions can be adjusted based on the pathloss between the two communicating UEs.

Regarding physical layer procedure for CSI report, for unicast, channel state information reference signal (CSI-RS) is supported for CSI measurement and reporting in sidelink. A CSI report is carried in a SL MAC CE.

For measurement on the sidelink, the following UE measurement quantities are supported:
PSBCH reference signal received power (PSBCH RSRP);
PSSCH reference signal received power (PSSCH-RSRP);
PSCCH reference signal received power (PSCCH-RSRP);
Sidelink received signal strength indicator (SL RSSI);
Sidelink channel occupancy ratio (SL CR);
Sidelink channel busy ratio (SL CBR).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km2 in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (also known as transmission time interval (TTI)) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

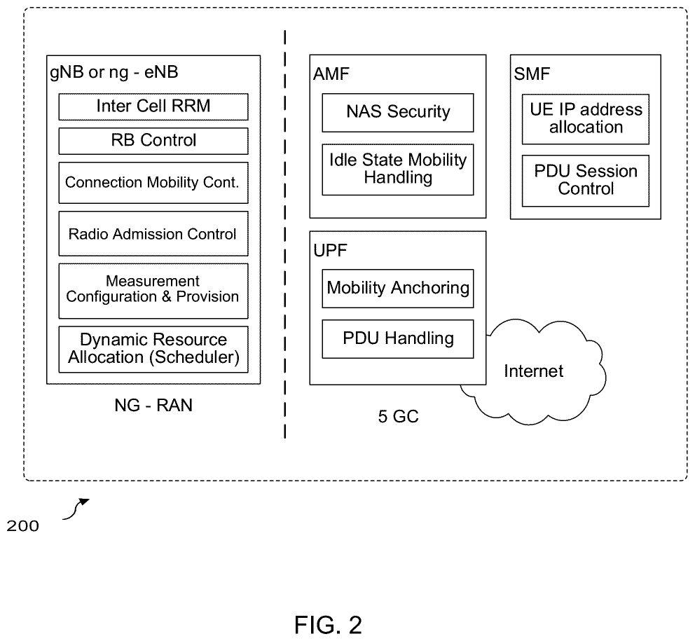

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

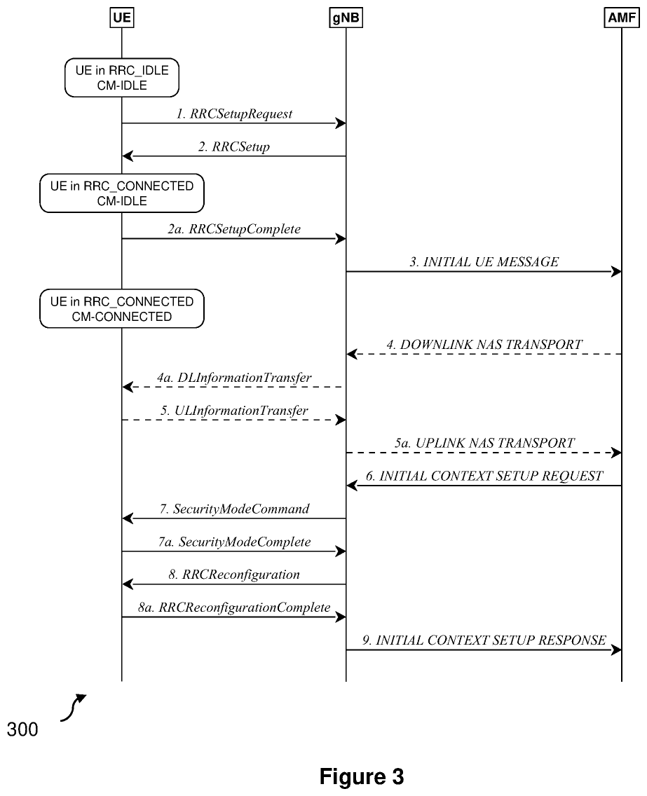

FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502.
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the Security ModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

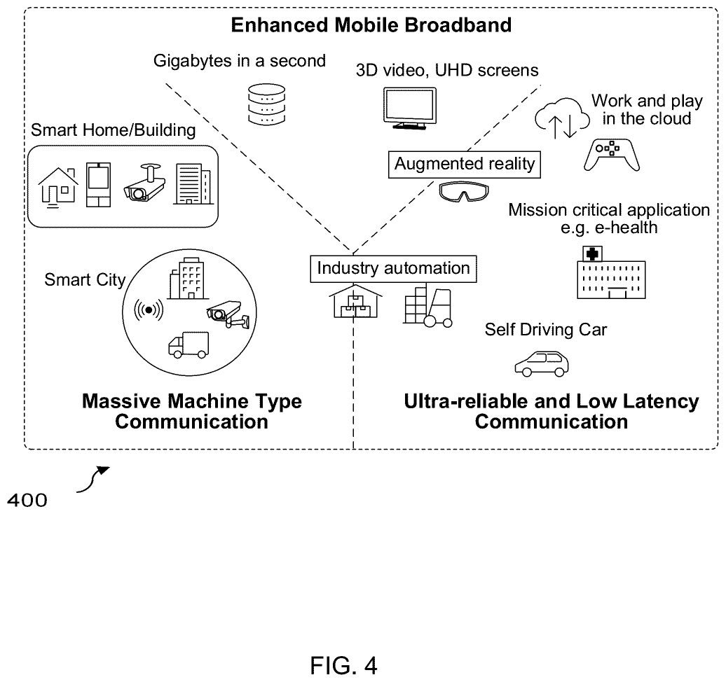

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few us where the value can be one or a few us depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QOS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

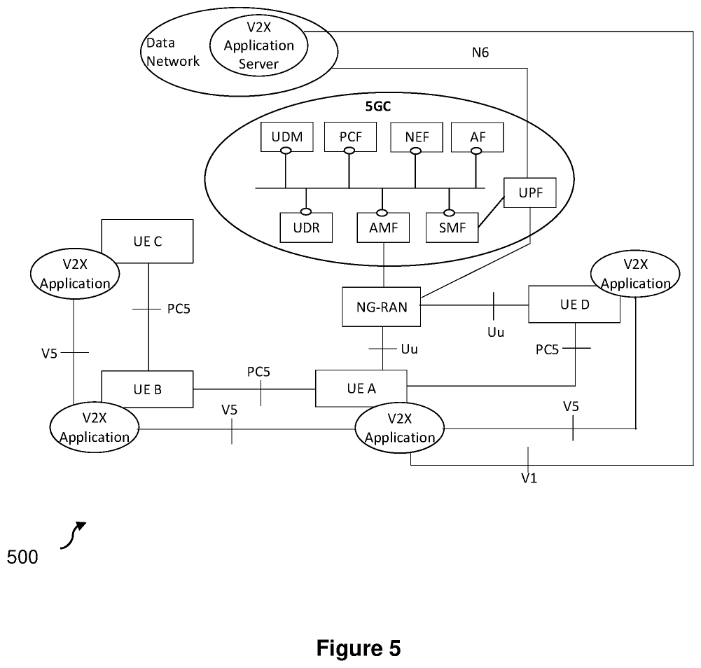

FIG. 5 illustrates a 5G NR non-roaming reference architecture (see TS 23.287 v16.4.0, section 4.2.1.1). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or 3rd party services. All of or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMMB and mMTC services to at least one of functions (for example NEF, AMF, SMF, PCF, UPF, etc) of the 5GC to establish a PDU session including a radio bearer between a gNodeB and a UE in accordance with the QoS requirement and control circuitry, which, in operation, performs the services using the established PDU session.

The following has been identified in R17 V2X WID (RP-210385) for DRX: more particularly, a sidelink (SL) DRX for broadcast, groupcast, and unicast:
Define on- and off-durations in sidelink and specify the corresponding UE procedure
Specify mechanism aiming to align sidelink DRX wake-up time among the UEs communicating with each other; and
Specify mechanism aiming to align sidelink DRX wake-up time with Uu DRX wake-up time in an in-coverage UE.

Further, RAN2 has made a working assumption that SL DRX should take PSCCH monitoring also for sensing (in addition to data reception) into account if SL DRX is used. In addition, RAN2 has made the following agreements relating to SL DRX:
1. Sidelink DRX needs to support sidelink communications for both in-coverage and out-of-coverage scenarios.
2. Support SL DRX for all casting types.
3. If a UE is in SL active time, UE should monitor PSCCH. FFS on PSSCH. FFS for sensing impacts.
4. As baseline, for Sidelink DRX for SL unicast, it is proposed to inherit and use timers similar to what are used in Uu DRX. FFS for SL broadcast/groupcast. FFS on detailed timers.
5. Support of long DRX cycle for SL unicast should be assumed as a baseline. FFS on the need of short DRX cycle.
6. Deprioritize SL WUS (Wake-Up Signal) from RAN2 point of view in Rel-17.
7. RAN2 will prioritize normal use case without consideration of relay UE use case in Rel-17.
8. RAN2 is not going to introduce SL paging and SL PO for SL DRX.

It is noted that from RAN2 perspective, the partial coverage case has not been precluded by the first agreement. RAN2 kindly asks RAN1 to provide feedback if there is any concern on the working assumption and take the above information into their future works.

In various embodiments below, a communication apparatus may refer to a sidelink UE. The sidelink UE may transmit and/or receive sidelink signals such as Physical Sidelink Control Channels (PSCCHs), Physical Sidelink Shared Channels (PSSCHs), Sidelink Synchronization Blocks (S-SSBs), Physical Sidelink Feedback Channels (PSFCHs), first-stage and second-stage Sidelink Control Information (SCI), Downlink Control Indication signal, Radio Resource Control signal, Media Access Control (MAC) Control Element (CE), Radio Resource Control (RRC) signal, Physical Downlink Control Channels (PDCCHs), Sidelink Synchronization Signals (SLSSs), Physical Sidelink Broadcast Channel (PSBCHs), and Physical Sidelink Feedback Channels (PSFCHs).

In various embodiments below, SL DRX cycles with its on- and off-duration may be (pre-) configured for SL communications. During semi-statically (pre-) configured SL DRX on-duration, an UE is active and allows SL reception and monitoring (sensing) whereas during semi-statically configured SL DRX off-duration, the UE is inactive and no SL reception, monitoring (sensing) is allowed. Such semi-statically (pre-) configured SL DRX on-duration and SL DRX off-duration may hereinafter be referred to and used interchangeably semi-static active duration and semi-static inactive duration respectively. In an embodiment, the UE is also allowed to receive and monitor a downlink signal such as a physical downlink control channel (PDCCH) within its SL DRX on-duration.

According to the present disclosure, two consecutive semi-statically configured SL DRX on-durations (semi-static active durations) separated by a semi-statically configured SL DRX off-duration (semi-static inactive duration) refer to as a first operating window and a second operating window throughout the present disclosure where the first operating window happens before the second operating window. The DRX state is switched to “ON” during semi-statically configured SL DRX on-durations, and is switched to “OFF” during semi-statically configured SL DRX off-durations. The semi-static inactive duration and/or the semi-static active duration may be duration specific for a downlink communication (e.g. DL DRX), duration specific for a sidelink communication (e.g. SL DRX) or duration for both of them.

According to various embodiments below, a time unit of “slot” may be used to represent a (pre-configured) finite length of an operating window, on-duration and off-duration. Such time unit of “slot” could also be extended to “multi-slot”, “mini-slot” or “symbol”.

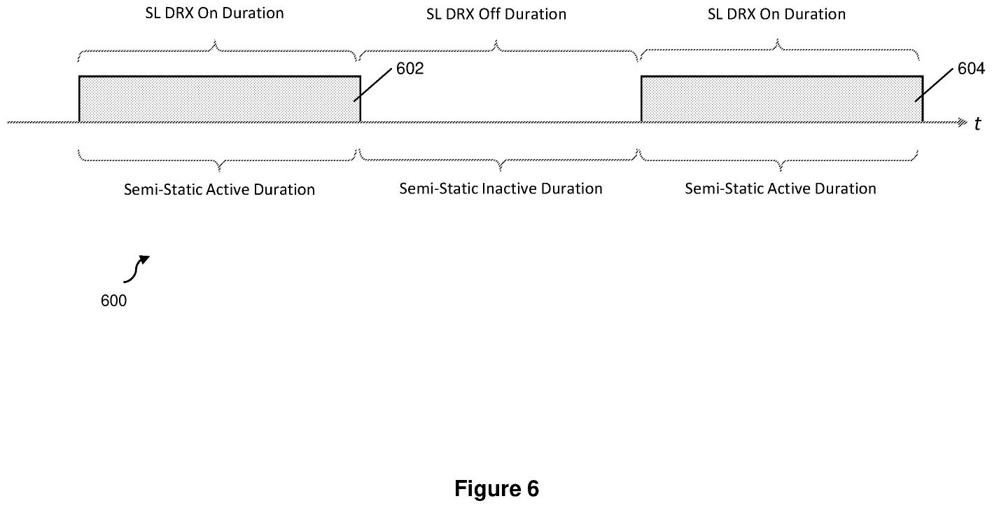

FIG. 6 depicts a first operating window (SL DRX on-duration) 602 and a second operating window 604. Conventionally, a UE can receive and/or transmit a sidelink signal during the first operating window 602 and the second operating window 604, whereas during semi-static inactive duration between the first operating window 602 and the second operating window 604, no SL reception/monitoring/transmission of a sidelink signal is allowed.

According to the present disclosure, a communication apparatus may be configured to allocate one or more additional operating windows between a first operating window and a second operation window for a reception or a transmission of a sidelink signal.

For a SL UE with semi-statically configured operating windows, the slot(s) between such two operating windows (i.e. within semi-static inactive duration) could be switch from an “OFF” state to an “ON” state to form one or more additional operating windows for SL reception, monitoring, i.e. additional sensing windows and/or for a SL transmission. The additional operating window(s) or slot(s) between the operating windows could be determined by higher layer, a sidelink signal or a downlink signal and realized by determination parameters such as a length parameter, a timer parameter, a bitmap and a rule. It is noted that “OFF” state means the SL UE is inactive and no SL reception/monitoring including sensing is allowed whereas “ON” state means the SL UE is active and allows SL reception/monitoring including sensing.

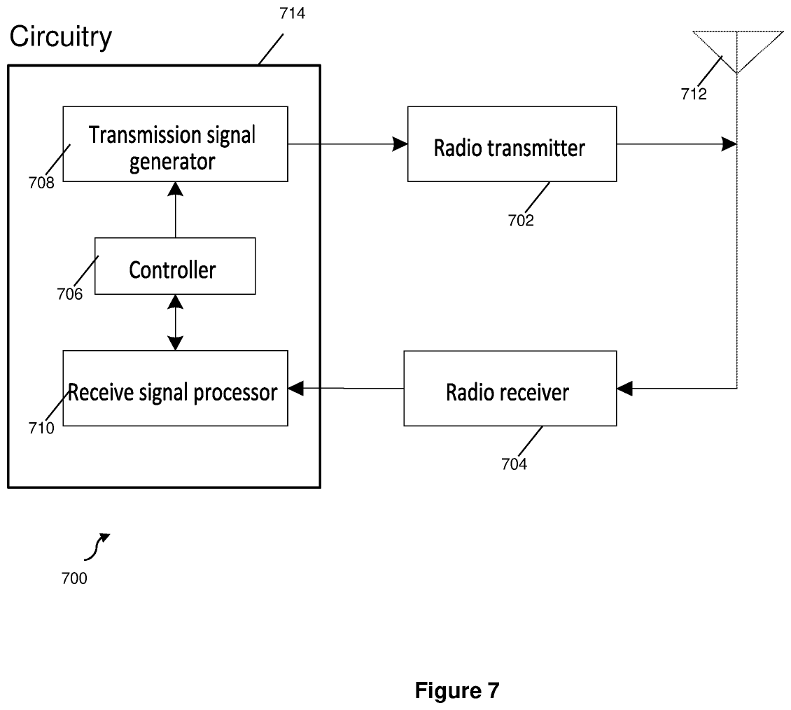

FIG. 7 shows a schematic diagram illustrating an example configuration of a communication apparatus 700 for allocating one or more additional operating window between a first operating window and a second operating window for a reception or a transmission of a sidelink signal in accordance with the present disclosure. The communication apparatus 700 may be implemented a user equipment (UE) and configured for a sidelink signal transmission or reception in accordance with the present disclosure. As shown in FIG. 7, the communication apparatus 700 may include circuitry 714, at least one radio transmitter 702, at least one radio receiver 704, and at least one antenna 712 (for the sake of simplicity, only one antenna is depicted in FIG. 7 for illustration purposes). The circuitry 714 may include at least one controller 706 for use in software and hardware aided execution of tasks that the at least one controller 706 is designed to perform, including control of communications with one or more other communication apparatuses in a multiple input and multiple output (MIMO) wireless network. The circuitry 714 may furthermore include at least one transmission signal generator 708 and at least one receive signal processor 710. The at least one controller 706 may control the at least one transmission signal generator 708 for generating a downlink signal or a sidelink signal to be sent through the at least one radio transmitter 702 and the at least one receive signal processors 710 for processing a downlink signal or a sidelink signal received through the at least one radio receiver 704 from the one or more other communication apparatuses. The at least one transmission signal generator 708 and the at least one receive signal processor 710 may be stand-alone modules of the communication apparatus 700 that communicate with the at least one controller 706 for the above-mentioned functions, as shown in FIG. 7. Alternatively, the at least one transmission signal generator 708 and the at least one receive signal processor 710 may be included in the at least one controller 706. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 702, at least one radio receiver 704, and at least one antenna 712 may be controlled by the at least one controller 706.

The communication apparatus 700, when in operation, provides functions required for allocating one or more additional operating window between a first operating window and a second operating window for a reception or a transmission of a sidelink signal. For example, the communication apparatus 700 may be a UE and the circuitry 714 may be configured to, in operation, allocate one or more additional operating windows between a first operating window and a second operating window for a reception or a transmission of a sidelink signal. The at least one radio receiver 704 may, in operation, receive a sidelink signal within the one or more additional operating windows. Alternatively or additionally, the at least one radio transmitter 702 may, in operation, transmit a sidelink signal within the one or more additional operating windows.

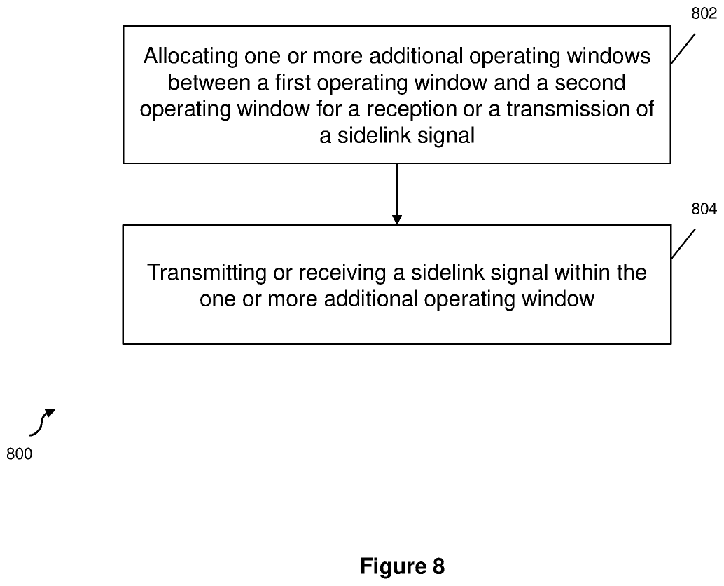

FIG. 8 shows a flow chart 800 illustrating a communication method for allocating one or more additional operating window between a first operating window and a second operating window for a reception or a transmission of a sidelink signal according to various embodiments of the present disclosure. In step 802, a step of allocating one or more additional operating windows between a first operating window and a second operating window for a reception or a transmission of a sidelink signal is carried out. In step 804, a step of transmitting or receiving a sidelink signal within the one or more additional operating window is carried out.

In the following paragraphs, a first embodiment of the present disclosure is explained with reference to an allocation of a contiguous operating window between a first operating window and a second operating window which is backwardly extended from a start of the second operating window.

For a SL UE configured with periodic operating windows (e.g., SL DRX), it is currently no solution for allocating an additional operating window (hereinafter may be referred to as “slot”) between two operating windows (i.e., within the SL DRX semi-static inactive duration between two SL DRX semi-static active durations or two SL DRX on-durations) for a reception/monitoring (e.g., sensing) of a sidelink signal or a transmission of a sidelink signal. In other words, there is no solution for the overlap of sensing window and SL DRX semi-static inactive duration that whether sensing is allowed. This is especially that when a triggering slot (e.g., transmission trigger slot) in an operating window is located near to the beginning of the operating window.

In the first embodiment of the present disclosure, a contiguous operating window is determined and allocated through backward extension from the beginning of the operating window within its preceding semi-static inactive duration or SL DRX off-duration as an additional operating window is proposed such that a SL signal reception/monitoring and/or transmission can be performed in the determined slots.

In an embodiment, especially for a mode-2 UE performing transmission, a length parameter or a new timer parameter (e.g. BackwardTimer) can be used to determine a length of the contiguous operating window or slot(s) extended backwardly from a start of an operating window, i.e. right before the 1^{st} slot of SL DRX semi-static active duration, within the preceding semi-static inactive duration or SL DRX off-duration. The UE is switched on for the slot(s) determined by the new timer parameter and is able to perform SL reception/monitoring (sensing) operation within the slot(s).

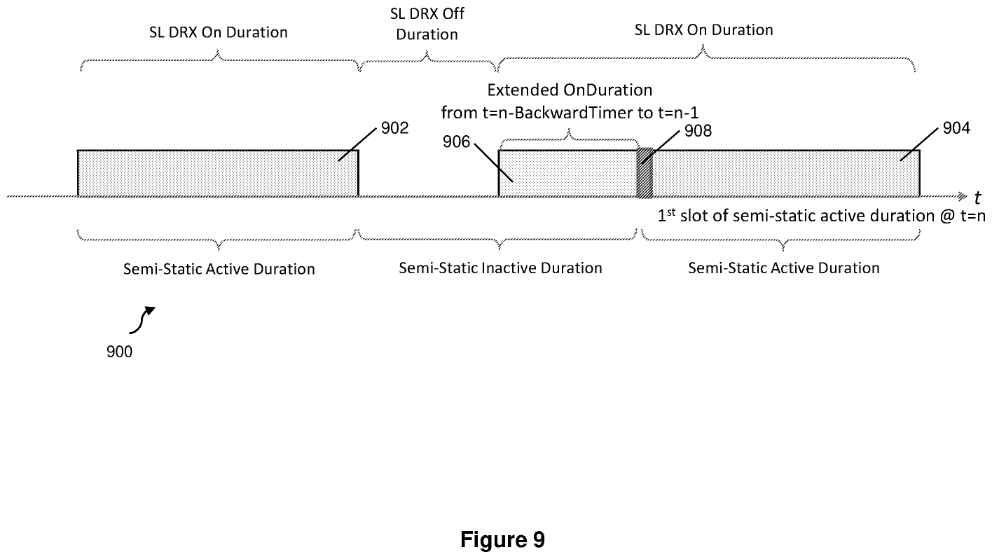

FIG. 9 shows a block diagram illustrating a contiguous operating window 906 allocated between a first operating window 902 and a second operating window 904 of a UE and extended from the second operating window 904 according to an embodiment of the present disclosure. In this embodiment, the length of the contiguous operating window 906 extended backwardly and located right before the 1^{st} slot (t=n) 908 of the second operating window 904 (i.e. within semi-static inactive duration between the first operating window 902 and the second operating window 904) is calculated based on a value of the new timer parameter (e.g. BackwardTimer) with respect to the 1^{st} slot (t=n) 908 of the on-duration, and the contiguous operating window 906 is started from t=n-BackwardTimer to t=n−1. The semi-static inactive duration and/or the semi-static active duration are duration specific for a downlink communication, duration specific for a sidelink communication or duration for both of them.

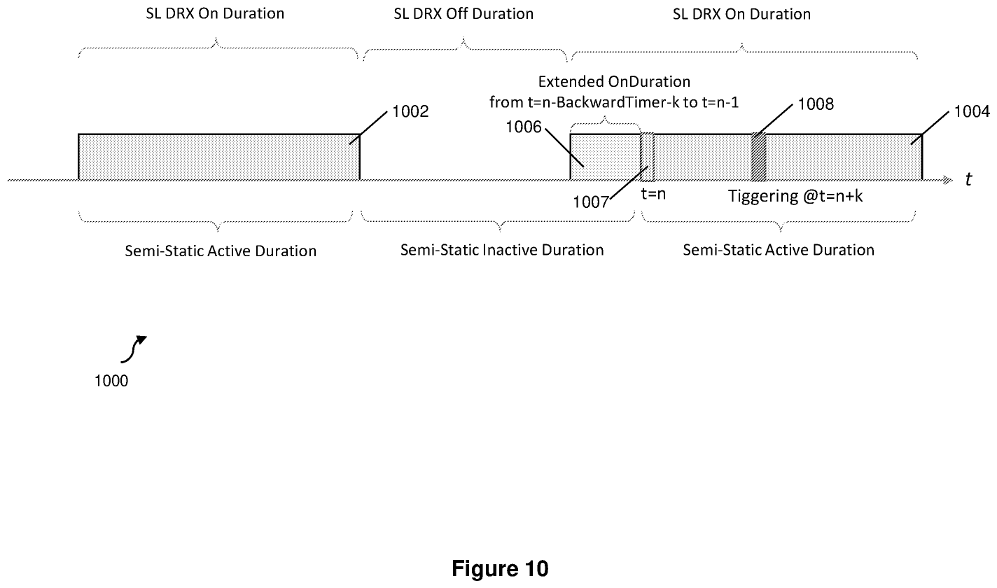

FIG. 10 shows a block diagram illustrating a contiguous operating window 1006 allocated between a first operating window 1002 and a second operating window 1004 of a UE and extended from the second operating window 1004 according to another embodiment of the present disclosure. In this embodiment, the length of the contiguous operating window 1006 extended backwardly and located right before the 1^{st} slot (t=n) 1007 of the second operating window 1004 is calculated based on a value of the new timer parameter (e.g. BackwardTimer) with respect to a transmission trigger slot 1008 at t=k within the second operating window 1006, and the contiguous operating window 1006 is started from t=n−BackwardTimer−k to t=n−1.

Such backward extension switching-on could be enabled by instructions from high layers (e.g., using a one-bit EnableBackwardTimer as a MAC Control Element (CE) or a RRC message), SCI information bits received from other UEs (e.g. in a previous trigger block, from a controlling UE, from a master UE, etc.) received during its previous reception duration to receive the enabling SCI, a DL signalling, an always-on configuration or up to implementation. In an embodiment, the backward extension switching-on can also apply to a SL mode-1 UE which could be additionally based on a reception of a DL signal before a transmission of a SL signal or enabled by a RRC message carried by a DL signal.

In the following paragraphs, a second embodiment of the present disclosure is explained with reference to an allocation of a contiguous operating window between a first operating window and a second operating window which is forwardly extended from an end of the first operating window.

SL UEs may have different SL DRX configurations, and the correlation co-efficient of any two UE's SL DRX could be high to 1 or low to 0. The transmission from a Tx UE may not successfully delivered to a target RX UEs without proper DRX synchronization. Also, when a triggering slot or a NACK feedback is closed to the end of a semi-static inactive duration, the SL UE may not have enough time for a reception and/or a transmission of a sidelink signal. Hence, a contiguous operating window extended from the end of the operating window may advantageously provide additional operating window for DRX synchronization and time for reception or transmission.

Similar to the backward extension, a length parameter or a new timer parameter (e.g., ForwardTimer) can be used to determine a length of the contiguous operating window or slot(s) extended forwardly from an end of an operating window, i.e., right after the 1^{st} slot of SL DRX semi-static active duration, within the preceding semi-static inactive duration or SL DRX off-duration. The UE is switched on for the slot(s) determined by the new timer parameter and is able to perform SL reception/monitoring (sensing) operation within the slot(s). It could also be independent timer parameters (e.g., ForwardTimerTx, ForwardTimerRx) for transmission and reception respectively.

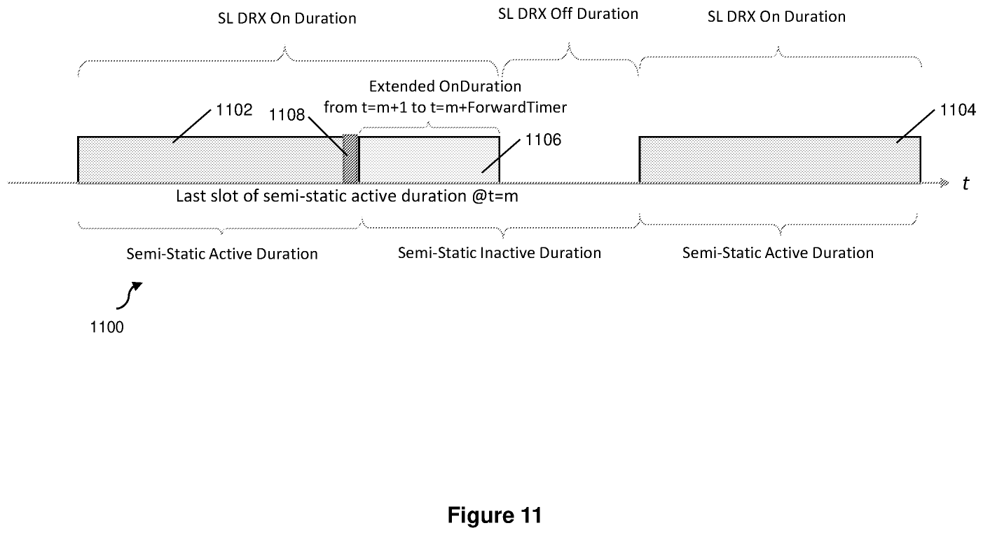

FIG. 11 shows a block diagram illustrating a contiguous operating window 1106 allocated between a first operating window 1102 and a second operating window 1104 of a UE and extended from the first operating window 1102 according to an embodiment of the present disclosure. In this embodiment, the length of the contiguous operating window 1106 extended forwardly and located right after the last slot (t=m) 1108 of the first operating window 1102 (i.e. within semi-static inactive duration between the first operating window 1102 and the second operating window 1104) is calculated based on a value of the new timer parameter (e.g. ForwardTimer) with respect to the last slot (t=m) 1108 of the on-duration, and the contiguous operating window 1106 is started from t=m+1 to t=m+ForwardTimer.

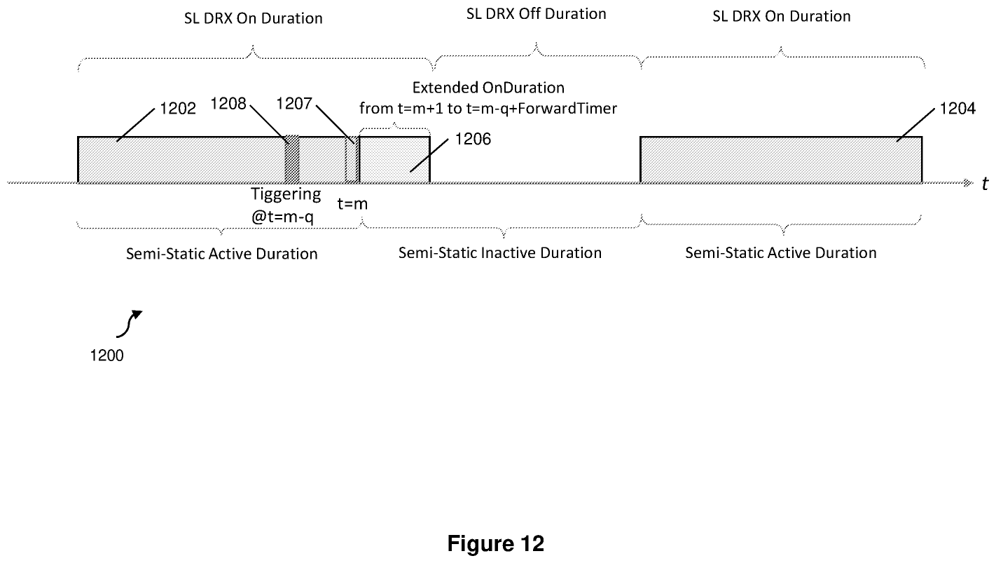

FIG. 12 shows a block diagram illustrating a contiguous operating window 1206 allocated between first operating window 1202 and a second operating window 1204 of a UE and extended from the first operating window 1202 according to another embodiment of the present disclosure. In this embodiment, the length of the contiguous operating window 1206 extended forwardly and located right after the last slot (t=m) 1207 of the first operating window 1202 is calculated based on a value of the new timer parameter (e.g. ForwardTimer) with respect to a transmission trigger slot 1208 at t=m-q within the first operating window 1204, and the contiguous operating window 1206 is started from t=m+1 to t=m−q+ForwardTimer.

For transmission, such forward extension switching-on right after the first operating window 1202 can be enabled by at least one of instructions from higher layers (e.g. an one-bit EnableForwardTimerTx as a MAC CE or a RRC message), PSFCH received in a previous reception duration (e.g. an operating window or a SL DRX on-duration prior to the first operating window 1202, a previously allocated additional operating window extended from an operating window prior to the first operating window 1202, pre-emption, reservation, etc.), some new or reused SCI information bits received in a previous reception duration, a new or reused DL signalling, an always-on configuration or up to implementation.

For reception, the forward extension switching-on right after the first operating window 1202 can be enabled by at least one instructions from higher layers (e.g., a one-bit EnabledForwardTimerRx as a MAC or a RRC message), a PSFCH triggered in current reception duration (e.g. the first operating window 1202), some new or reused SCI information bits received in previous or current reception duration, a reception decoding results (e.g., a NACK for failed reception) for a received trigger block, a new or reused DL signalling, an always-on configuration or up to implementation.

The length parameter or the timer parameter (e.g., BackwardTimer, ForwardTimer) can be (pre-) configured by regulators/operators/vendors, application layer, UE internal generation or specified by standards. In an embodiment, the timer parameter (e.g., BackwardTimer, ForwardTimer) could be implemented as RRC information elements in either ENUMERATED, INTETGER, SEQUENCE, CHOICE, etc. format, such as BackwardTimer ENUMERATED {ms10, ms20 ms, ms30}.

different lengths of the additional operating window through backward/forward extension can also be configured with different enabling schemes such as different power-saving modes. For example, for the switched-on slots (e.g., for sensing) located in SL DRX semi-static inactive duration, the switching-on timer parameter (e.g., BackwardTimer, ForwardTimer) could have different levels with different numbers of switched-on slots for each level. This is for trade-offs between power saving (low-to-high) and UE performance (high-to-low) as following (more levels if needed). Examples of different new timer parameters configured for different power-saving modes/levels are as follows:
Level 0: Entire full/partial sensing window allowed in SL DRX-off duration
Level 1: A longer truncated full/partial sensing window allowed (e.g., specified max/min or extension limit) allowed in SL DRX-off duration
Level 2: A shorter truncated full/partial sensing window allowed (e.g., specified max/min or extension limit) allowed in SL DRX-off duration
Level 3: No sensing allowed during SL DRX-off duration

Additionally or alternatively, an additional operating window within the semi-static inactive duration and the new parameter (e.g. BackwardTimer, ForwardTimer) could be triggered by higher layers when at least one of the following conditions is met: (i) when a triggering signalling in a semi-static active duration (e.g. the second operating window) is before a threshold slot or a duration between a transmission trigger slot within the semi-static active duration and the start of the semi-static active duration is less than a threshold duration, i.e. a transmission trigger slot is too close to the start of semi-static active duration, a backward extension may be applied to allocate an additional operating window so to ensure there is enough window for sensing; (ii) when a triggering signaling in a semi-static active duration (e.g. first operating window) is after a threshold slot or a duration between a transmission trigger slot within the semi-static active duration and the end of the semi-static active duration is less than a threshold duration, i.e. a transmission triggering slot is too close to the end of the semi-static active duration; a forward extension from the semi-static active duration may be applied to allocate an additional operating window so to ensure there is have enough time for a SL transmission; (iii) when a negative decoding result (e.g. NACK) is received close to the end of the semi-static active duration or a duration between a reception of a negative decoding result and the end of the semi-static active duration is less than a threshold duration, a forward extension from the semi-static active duration may be applied to allocate an additional operating window so to ensure there is enough time for a SL re-transmission; and (iv) when there is an unsuccessful decoding event of a received sidelink signal close to the end of the semi-static active duration, a forward extension from the semi-static active duration may be applied to allocate an additional operating window so to ensure there is enough time for receiving a SL re-transmission.

Additionally or alternatively, an additional operating window within the semi-static inactive duration and the new parameter (e.g. BackwardTimer, ForwardTimer) could also be triggered when a parameter such as a number of consecutive failed receptions/transmissions, a time period without a successful reception/transmission, a successful reception/transmission ratio is smaller or greater than a desired threshold value.

For forward extension, the length of the semi-static active duration, i.e., the contiguous operating window extended from the end of the operating window, may be indefinitely extended by the timer parameter to remain active until a certain stop condition(s) is met. Examples of a stop condition includes a time when a PSFCH, an ACK or a NACK has been received by a Tx UE, a time when a PSFCH, an ACL or a NACK has been transmitted by a Rx US and a time when successful transmission, reception or decoding event has been completed.

Additionally or alternatively, a gradual increase (or decrease) in the length of the contiguous operating window between the first operating window and the second operating window may be applied to consecutive SL DRX semi-static active durations. That is, respective lengths of a first contiguous operating window extended from a first semi-static active duration, a second contiguous operating window extended from a second semi-static active duration, and a third contiguous operating window extended from a third semi-static active duration may be gradually incremented (or decremented). For example, an increment value of 1 slot may be applied such that a one-slot extension is allocated for the first semi-static active duration, a two-slot extension is allocated for 2^{nd} semi-static active duration and a three-slot extension is allocated for the 3^{rd} semi-static active duration. Although it is shown 1-3 extension values and a gradual 1-slot increment in respective lengths of consecutive contiguous operating windows is applied, different extension values or increment/decrement values could be applied. Yet in another example, a desired length of the contiguous operating window within the semi-static inactive period may be determined, and the UE is configured to gradually increase/decrease the allocated length of each subsequent contiguous operating window to the desired length of extension only after a number of semi-static active durations or SL DRX cycles.

Other than using the timer parameter to determine a length of switched-on slots, a SL could also be configured with some rules to resolve sensing during SL DRX semi-static inactive duration. For example, a sensing window may be (pre-) configured for the UE to receive and monitor a SL signal. According to the present disclosure, if a sensing window of an UE or a portion thereof overlaps with a SL DRX semi-static inactive duration, the UE will be configured to allocate a contiguous operating window (or, if a contiguous operating window has been allocated, further set or increase a length of the contiguous operating window) to cover the entire length of the overlapped portion/duration, i.e. the sensing slots located within the SL DRX semi-static inactive duration, such that the UE can still perform sensing or other operation during the sensing window. Such additional operating window allocated to cover a sensing window or a portion thereof that falls within a semi-static inactive duration may be referred to a SL inactive sensing duration.

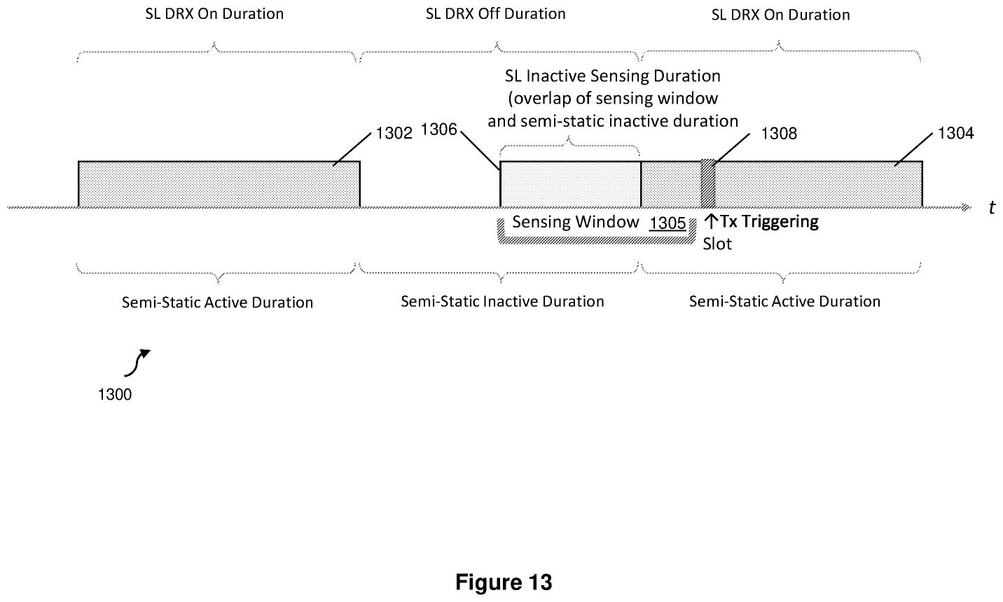

FIG. 13 shows a block diagram 1300 illustrating an additional operating window 1306 allocated between a first operating window 1302 and a second operating window 1304 of a UE configured with a sensing window 1305 according to an embodiment of the present disclosure. A portion of the sensing window 1305 overlaps with a semi-static inactive duration between the first operating window 1302 and the second operating window 1304. An additional operating window 1306 is thus allocated to the overlapped portion of the sensing window 1305 and the semi-static inactive duration. In this embodiment, the additional operating window 1306 is not set to a SL DRX “ON” state and remain in DRX “OFF” state such that the UE is allowed to perform a reception/monitoring (sensing) of a sidelink signal during the additional operating window 1306.

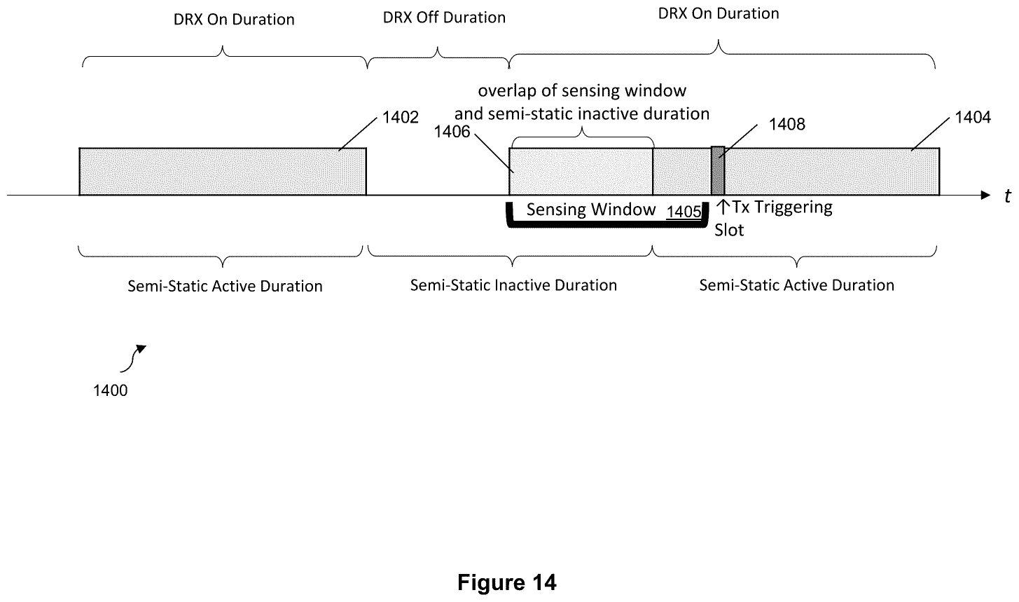

FIG. 14 shows a block diagram 1400 illustrating an additional operating window 1406 allocated between a first operating window 1402 and a second operating window 1404 of a UE configured with a sensing window according to another embodiment of the present disclosure. A portion of the sensing window 1405 overlaps with a semi-static inactive duration between the first operating window 1402 and the second operating window 1404. An additional operating window 1406 is thus allocated to the overlapped portion of the sensing window 1405 and the semi-static inactive duration. In this embodiment, the additional operating window 1406 may be set to a SL DRX “ON” state such that the UE is allowed to perform a reception/monitoring (sensing). and a transmission of a sidelink signal during the additional operating window 1406.

Although the configuration of a SL inactive sensing duration in FIGS. 13 and 14 is illustrated using the additional operating window allocated through backward extension, it is appreciable that the same can be applied to other additional operating windows discussed in the present disclosure such as that allocated through forward extension depending on the portion of the semi-static inactive duration which the sensing window overlaps.

In the following paragraphs, a third embodiment of the present disclosure is explained with reference to an allocation of one or more discrete additional operating windows between a first operating window and a second operating window and separated from the first operating window and the second operating window to achieve configurable wake-up instances between the first and the second operating windows.

Considering a partial sensing may have discrete sensing slots in the corresponding sensing window, one or more discrete additional operating windows (hereinafter referred to as “discrete slots”) can also be configured and allocated within two operating windows. Such discrete additional operating windows can be achieved by a parameter in the format of a bitmap (e.g., WakeupBitmap). The bitmap could be with reference to the first slot or the last slot of a semi-static inactive duration.

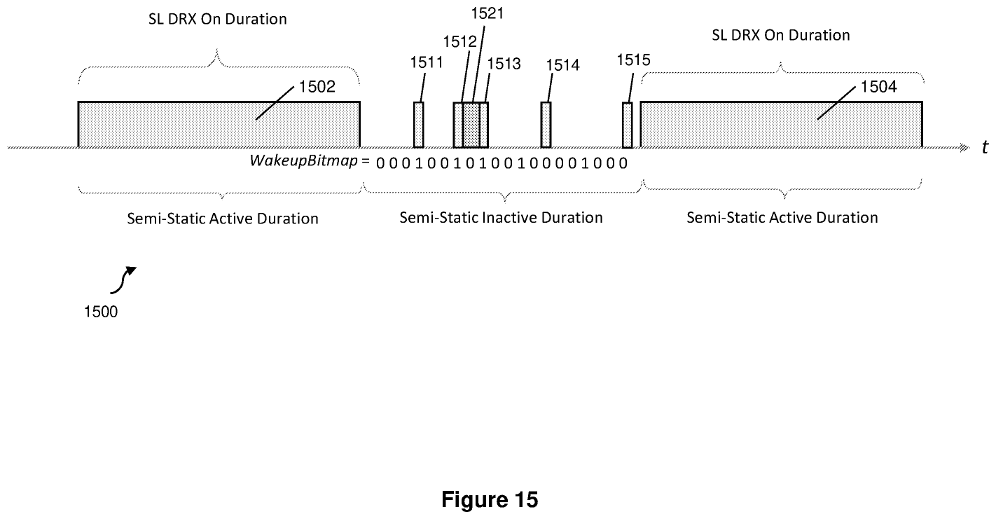

FIG. 15 shows a block diagram 1500 illustrating five discrete operating windows 1511, 1512, 1513, 1514, 1515 allocated between a first operating window 1502 and a second operating window 1504 of a UE and separated from the first and the second operating windows 1502, 1504 according to an embodiment of the present disclosure. In this embodiment, a bitmap WakeupBitmap of [0 0 0 1 0 0 1 0 1 0 0 1 0 0 0 0 1 0 0 0] may be configured with reference to the first slot or the last slot of a semi-static inactive duration where a value of “1” bitmap indicates an allocation of a discrete additional operating window and a switch to a SL DRX-on slot within the semi-static inactive duration. Five discrete operating windows 1511-1515 are allocated at 4^{th}, 7^{th}, 9^{th}, 12^{th} and 17^{th} slots within the semi-static inactive duration according to the bitmap WakeupBitmap.

The bitmap may be configured to have the same/longer/shorter length to a semi-static inactive duration and could also be repeatedly applied. For Tx UEs, the bitmap could also largely cover the sensing slots of the partial sensing window inside the SL DRX semi-static inactive duration. The bitmap can be (pre-) configured by regulators/operators/vendors, application layer, UE internal generation or specified by standards. Different bitmaps can also be configured for different enabling schemes such as different power-saving modes.

Such switching-on slots determined by a bitmap could be enabled by some new or reused SL signalling received in previous or current reception duration (e.g., pre-emption/reservation) when a UE's bitmap is known by a controlling UE or a master UE or for an inter-UE coordination, instructions from high layers (e.g., using an one-bit EnableWakeupBitmap as a MAC Control Element (CE) or a RRC message), a DL signalling, an always-on configuration or up to implementation.

Returning to FIG. 15, where the UE may require additional time for state transition during certain power state (e.g., light or deep sleep power state) adopted by the UE, a redundant additional operating window 1521 or SL DRX on-duration between two discrete slots for sensing like 1512, 1513 may be allocated and switched to “ON” state to ensure the required amount of on-duration and slots needed for state transition is allocated.

According to various embodiment, additional operating windows via backward extension, forward extension and configurable wake-up can be allocated individually or jointly between the semi-statically configured SL DRX. Such joint allocations and operations can be enabled by downlink or sidelink signalling using one bit carried by DCI or SCI for one operation or type of additional operating window, where a “0” indicates to apply additional operating window and an “1” indicates not to apply any additional operating window. For example, 1 bit for backward extension, 1 bit for forward extension and 1 bit for configurable wake-up, and it could be a combined 3 bits signal if all operations are to be applied. The enabling of switching-on slots can also be a reused PSFCH, 1^{st} stage SCI, 2^{nd} stage SCI or DCI. For example, the reservation information field with SCI can enabled the switching-on.

The signalling can also be a combined indication by several bits carried by 1^{st} stage SCI, 2^{nd} stage SCI or DCI information. For example, “00” indicates no extension/wake-up, “01” indicates to enable backward extension, “10” indicates to enable forward extension, “11” enable to apply configurable extension. For forward extension, the signalling could also be a reused PSFCH, 1^{st}/2^{nd} stage SCI or DCI information. For example, a forward timer is enabled when “NACK” is received via PSFCH.

If there is an overlap in the allocated slots, either a Boolean logic (AND, OR, etc.), a new parameter to override can be applied to the overlapped duration. Alternatively, the UE may be configured to maintain the existing parameter and to apply a new parameter for only the non-overlapped duration.

A size limitation could be applied to the number of switched-on slots within a semi-static inactive duration. The limitation could be minimum/maximum value/ratio of a semi-static inactive duration. For example, as the original sensing window could be as large as 1100 ms, some limitation could be applied to have a full or truncated sensing window within a semi-static inactive duration. The size of the number of switched-on slots could also be a fixed value/ratio, which could be same as the configured size of the sensing window, a pre-determine number (e.g., 32 slots), etc.

The parameters (e.g., value of time parameter, bitmap), conditions (e.g. stop conditions) and rules may be configured differently among UEs of different categories, UEs performing different operations or UEs with different priorities which includes but not limited to SL UE performing Tx or Rx operations, SL UE performing broadcast/groupcast/unicast transmission/receptions, SL UE with or without feedback enabled and SL UEs with resource allocation mode-1 or mode-2.

Further, besides the parameters, conditions and rules, other formats like formulas, descriptive rules could also be additionally or alternatively applied to carry out the above embodiments and solutions.

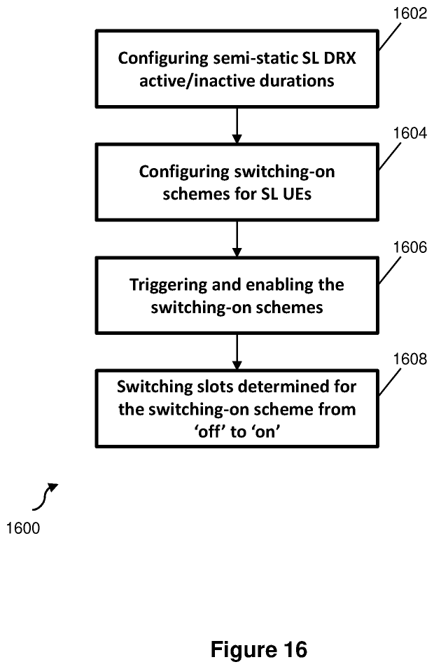

FIG. 16 shows a flow chart 1600 illustrating a process of allocating one or more additional operating windows between a first operating window and a second operating window carried out by a communication apparatus according to various embodiments of the present disclosure. In step 1602, a step of configuring semi-static SL DRX active/inactive durations is carried out. In step 1604, a step of configuring switching-on schemes for SL UEs is carried out. In step 1606, a step of trigger and enabling the switching-on schemes is carried out. In step 1608, a step of switching slots determined for the switching-on scheme from “off” to “on” is carried out.

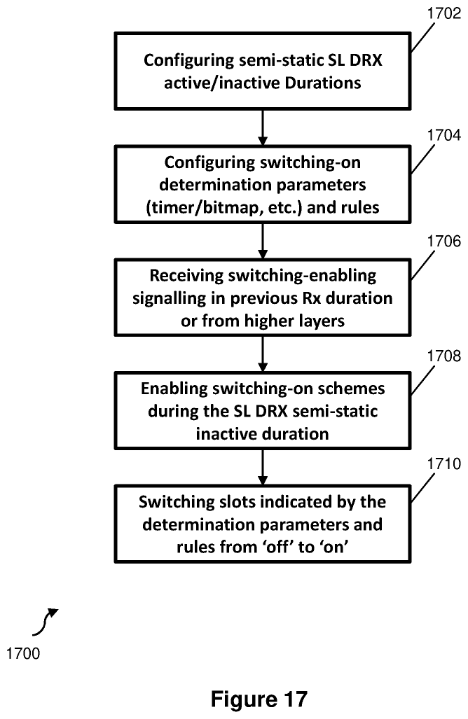

FIG. 17 shows a flow chart 1700 illustrating a process of allocating one or more additional operating windows between a first operating window and a second operating window carried out by a transmitter (Tx) communication apparatus according to various embodiments of the present disclosure. In step 1702, a step of configuring semi-static SL DRX active/inactive durations is carried out. In step 1704, a step of configuring switching-on determination parameters (e.g., timer/bitmap, etc.) and rules is carried out. In step 1706, a step of receiving switching-enabling signalling in previous Rx duration or from higher layers is carried out. In step 1708, a step of enabling switching-on schemes during the semi-static inactive duration is carried out. In step 1710, a step of switching slots indicated by the determination parameters and rules from “off” to “on” is carried out.

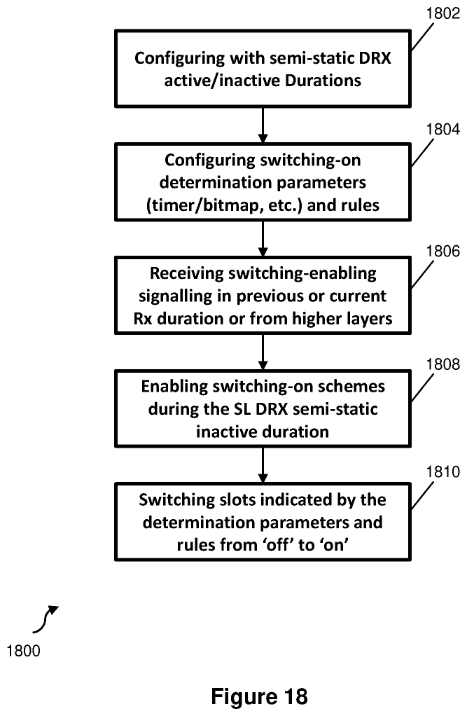

FIG. 18 shows a flow chart 1800 illustrating a process of allocating one or more additional operating windows between a first operating window and a second operating window carried out by a receiver (Rx) communication apparatus according to various embodiments of the present disclosure. In step 1802, a step of configuring with semi-static SL DRX active/inactive durations is carried out. In step 1804, a step of configuring switching-on determination parameters (timer/bitmap, etc.) and rules is carried out. In step 1806, a step of receiving switching-enabling signalling in previous or current Rx duration or from high layers is carried out. In step 1808, a step of enabling switching-on schemes during the semi-static inactive duration is carried out. In step 1810, a step of switching slots indicated by the determination parameters and rules from “off” to “on” is carried out.

In the following paragraphs, certain exemplifying embodiments are explained with reference to terms related to 5G core network and the present disclosure regarding communication apparatuses and methods for allocating one or more additional operating windows between two semi-statically configured SL DRX cycles for a reception or a transmission of a SL signal, namely:

### Control Signals

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1^{st} stage sidelink control information (SCI) or the 2^{nd} stage SCI.

### Base Station

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in sidelink communication, a terminal may be adopted instead of a base station. The base station may be a relay apparatus that relays communication between a higher node and a terminal. The base station may be a roadside unit as well.

### Uplink/Downlink/Sidelink

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### Data Channels/Control Channels

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### Reference Signals

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### Time Intervals

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### Frequency Bands

The present disclosure may be applied to any of a licensed band and an unlicensed band.

### Communication

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### Antenna Ports

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g, cellular (cell) phone, smart phone), a tablet, a personal computer (PC) (e.g, laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
circuitry which, in operation, is configured to allocate one or more additional operating windows between a first operating window and a second operating window for a reception or a transmission of a sidelink signal; and
a transceiver which, in operation, transmit or receive a sidelink signal within the one or more additional operating window.

2. The communication apparatus of claim 1, wherein the circuitry is further configured to monitor a physical downlink control channel (PDCCH) within the first operating window and the second operating window.

3. The communication apparatus of claim 1, wherein the one or more additional operating windows is a contiguous operating window extended from an end of the first operating window and/or a start of the second operating window.

4. The communication apparatus of claim 3, wherein the circuitry is further configured set a length of the contiguous operating window based on a length of a sensing window, a portion of the sensing window falls between the end of the first operating window and the start of the second operating window.

5. The communication apparatus of claim 4, wherein the transceiver is configured to only receive a sidelink signal within the contiguous operating window.

6. The communication apparatus of claim 1, wherein the circuitry is further configured to:
determine if a duration between one of (i) a transmission trigger slot within the first operating window and the end of the first operating window, (ii) a transmission trigger slot within the second operating window and the start of the second operating window, (iii) a reception of a negative acknowledgement signal and the end of the first operating window, and (iv) an unsuccessful decoding event of a received sidelink signal and the end of the first operating window is less than a threshold duration, and the circuitry is configured to allocate the contiguous operating window based on a result of the determination respectively.

7. The communication apparatus of claim 3, wherein the circuitry is configured to allocate the contiguous operating window based on a parameter relating to at least one of a number of consecutive failed receptions, a time period without a successful transmission, a time period without a successful reception, a successful transmission ratio and a successful reception ratio.

8. The communication apparatus of claim 3, wherein the circuitry is further configured to set a length of the contiguous operating window extended from the second operating window based on a value of a timer and one of the start of the second operating window and a trigger slot within the second operating window.

9. The communication apparatus of claim 3, wherein the circuitry is further configured to set a length of the contiguous operating window extended from the first operating window based on a value of a timer and one of the end of the first operating window and a trigger slot within the first operating window.

10. The communication apparatus of claim 7, wherein the circuitry is configured to set a value of the timer for each of a plurality of power-saving modes of the communication apparatus.

11. The communication apparatus of claim 3, wherein the circuitry is configured to set a length of the contiguous operating window that is gradually incremented or decremented from at least one preceding contiguous operating windows allocated prior to the contiguous operating window and/or at least one subsequent contiguous operating windows subsequent to the contiguous operating window.

12. The communication apparatus of claim 3, wherein the circuitry is configured to further extend a length of the contiguous operating window after an end of the first operating window until the circuitry is determined that a physical sidelink feedback channel (PSFCH) or an acknowledgement signal has been transmitted/received to/from another communication apparatus or at least one of a successful transmission of a signal, a successful reception of a signal and a successful decoding event has been completed.

13. The communication apparatus of claim 1, wherein the one or more additional operating windows comprises one or more discrete operating windows separated from an end of the first operating window and a start of the second operating window, and the circuitry is configured to allocate the one or more discrete operating windows based on a bitmap.

14. The communication apparatus of claim 12, wherein the circuitry is configured to apply the bitmap corresponding to one of a plurality of power-saving modes of the communication apparatus.

15. The communication apparatus of claim 12, wherein the circuitry is configured to further allocate a redundant operating window extended from one of the one or more discrete operating window based on a time required for a state transition in one of a plurality of power states of the communication apparatus.

16. The communication apparatus of claim 1, wherein the transceiver further receives a signal during the first operating window or an operating window therebefore; and the circuitry is configured to allocate the one or more additional operating window based on the received signal.

17. The communication apparatus of claim 16, wherein the signal is one of a first stage Sidelink Control Information (SCI), a second stage SCI, a Downlink Control Information (DCI), a Radio Resource Control (RRC) message, a PSFCH and a Media Access Control (MAC) Control Element (CE).

18. A communication method comprising:
allocating one or more additional operating windows between a first and a second operating windows for a reception or a transmission of a sidelink signal; and
transmitting or receiving a sidelink signal within the one or more additional operating window.
